(19) United States
(12) Patent Application Publication
(10) Pub. No.: US 2004/0234832 A1
(43) Pub. Date: Nov. 25, 2004

(54) Solid state electrolytic fuel cell

(76) Inventors: Masahiro Kuroishi, Fukuoka (JP); Hiroyuki Nagaiwa, Fukuoka (JP); Susumu Aikawa, Fukuoka (JP)

Correspondence Address: BIRCH STEWART KOLASCH & BIRCH, PO BOX 747, FALLS CHURCH, VA, 22040-0747, US

(21) Appl. No.: 10/488,463

(22) PCT Filed: Sep. 6, 2001
(86) PCT No.: PCT/JP01/07721

(51) Int. Cl. H01M 8/12; H01M 8/24

(52) U.S. Cl. 429/31; 429/32; 429/34

(57) ABSTRACT

In a solid oxide fuel cell comprising cylindrical cells according to the present invention, a coupling portion for connecting cell stacks in series in a non-linear state comprises flat portions which are connected to current collecting members at the end of the cell stacks and a rod portion which electrically connects the flat portions. With this, since electric current flows through the rod, the electric resistance in each series connection has no difference between each parallel cell, and thereby electric current flows uniformly through all the cells. Consequently, power generation can be conducted uniformly in each cell, the amount of electric power generation in the whole system can be increased, and the durability can be improved because the electric current is prevented from being localized.

### TECHNICAL FIELD

This invention relates to a solid oxide fuel cell comprising cylindrical cells. More specifically, this invention relates to a solid oxide fuel cell comprising cylindrical cells in which improvements are introduced in a current collecting member for turning the direction of a series connection, and thereby electric power generation is conducted more uniformly in a plurality of cells, so that the efficiency of electric power generation, the durability and the reliability of the cells can be enhanced.

### BACKGROUND ART

A solid oxide fuel cell comprising cylindrical cells, which is one type of a solid oxide fuel cell, has been disclosed in Japanese Pre-grant Publication No. 1-59705. The solid oxide fuel cell comprises cylindrical cells each of which is comprised of a porous support tube, an air electrode, oxide, a fuel electrode, and an interconnection. When oxygen (air) is fed into the air electrode and gas fuel (H₂, CO and the like) is fed into the fuel electrode, O²⁻ ions move in the cell, which causes chemical combustion, and a potential difference is generated between the air electrode and the fuel electrode so as to produce electric power. Incidentally, another configuration is possible in which an air electrode functions as a support tube.

The material, the thickness, and the manufacturing method of a conventionally typical solid oxide fuel cell comprising cylindrical cells are as follows (Proc, of the 3^{rd} Int. Symp. On SOFC, 1993):

Support tube: ZrO₂ (CaO), Thickness 1.2 mm, Extrusion

Air electrode: La(Sr)MnO₃, Thickness 1.4 mm, Slurry coat

Oxide: ZrO₂ (Y₂O₃), Thickness 40 μm, EVD

Interconnection: La(Sr)MnO₃, Thickness 40 μm, EVD

Fuel electrode: Ni-ZrO₂ (Y₂O₃), Tickness 100 μm, Slurry coat-EVD

FIG. 7 shows the cross section of the main part of the conventional solid oxide fuel cell. In the common solid oxide fuel cell, each cylindrical cell provides around 1 vol. Accordingly, a plurality of cylindrical cells are connected in series in order to generate a desired voltage. Specifically, taking efficiency in fabrication and maintenance into account, a cell stack 607 is typically formed in which about three cells 601 are connected in parallel, three to six sets of these parallel cells are connected electrically in series by using conductive members 604, and a pair of current collecting members 605 are provided at both ends. The number of series connections can be adjusted in order to obtain sufficient voltage.

The cell 601 is a ceramic tube in which the upper end is open and the lower end is closed (a tubular shape having a bottom) The cross section of the cell 601 has a multilayered annular shape in which an air electrode 609, an oxide layer 608, and a fuel electrode 602 are layered.

Each layer of the cell 601 has a thickness of several μm−2 mm, and is made of a ceramic material which mainly includes oxide and has necessary functions (conductivity, air permeability, electrolyte, electrochemical catalytic property, and the like). When an oxidizer (air, oxygen rich gas and the like, which is referred to as “air” hereinafter) is fed into the inner surface of the cell 601 and fuel gas (H₂, CO, CH₄ and the like) is fed into the outer surface of the cell 601, O²⁻ ions move in the cell, which causes electrochemical reaction, and a potential difference is generated between the air electrode 609 and the fuel electrode 602 so as to produce electric power.

There is provided an elongated air introducing tube (not shown in the drawing) for passing air in the cell 601. The air introducing tube extends down from an air distributor (not shown in the drawing) which is located at the upper portion of the solid oxide fuel cell, and enters the cell 601. The lower end of the air introducing tube reaches near to the bottom of the cell 601, and air is supplied to the bottom of the cell 601 from the lower end of the air introducing tube. The supplied air goes up inside the cell 601 while contributing to the above-mentioned electric power producing reaction, and goes outside the cell 601 through the upper end of the cell 601. Finally, the air reaches an exhaust combustion chamber (not shown in the drawing). In the exhaust combustion chamber, as mentioned below, the exhaust fuel gas and the exhaust air are mixed, and oxygen and fuel which have not yet been reacted in the exhaust undergo combustion.

Fuel gas is supplied to the outer surface of the cell 601 in an upward direction from a fuel supplying chamber (not shown in the drawing) which is located at the lower portion of the solid oxide fuel cell. The supplied fuel gas goes up outside the cell 601 while contributing to the above-mentioned electric power producing reaction. The part of the fuel gas which has not yet been reacted, and electrochemical combustion reaction products (CO₂, H₂O and the like) generated in the cell enter the exhaust combustion chamber. Sensible beat after the combustion in the exhaust combustion chamber can be utilized for preheating air and fuel gas to be supplied to the fuel call, or sent to an electric power generating system which employs a common steam boiler and turbine for electric power generation.

With regard to the electric connection relationship of the cells 601, a lot of series connections are provided in the cell stack 607 so as to obtain sufficient voltage. In this instance, if a linear arrangement is employed, the cross section of the main part of the solid oxide fuel cell becomes an elongated rectangle shape, which increases the surface area of the main part of the solid oxide fuel cell and the heat release therefrom. Thus, it is desired that the cell stack be connected in series in a state of being tuned with a coupling portion 606 of a metal plate etc., and thereby the cells are arranged to be in a square shape as a whole, as shown in FIG. 6.

The conventional coupling portion 606 is made of a plate-like conductive material. Therefore, in the two cell stacks 607 which are arranged to be turned, the ratio of the electric resistance in the current path which leads to the cell 610, the current path which leads to the cell 611 and the current path which leads to the cell 612 is about 2:3:4 in a state shown in FIG. 7, for example. Since the electric resistance of the current path which leads to the cell 610 is smallest, electric current tends to flow dominantly through the cell 610. Consequently, the output is deteriorated compared to the case where the electric power generation is conducted uniformly in all the cells. Also, since the durability of the cell through which electric current dominantly flows is deteriorated, the reliability of the whole system is deteriorated.

### DISCLOSURE OF THE INVENTION

The present invention has been made to solve the above-mentioned problems, and the object of the present invention is to provide a solid oxide fuel cell comprising cylindrical cells in which electric power generation can be conducted more uniformly in all the cells.

According to a first aspect of the present invention, there is provided a solid oxide fuel cell comprising a plurality of cells connected in a series direction and a parallel direction, wherein the sum of the electric resistance of the current paths in each series direction is substantially the same.

With this, since electric current can flow uniformly by eliminating the difference in the resistance value, it is possible to conduct electric power generation uniformly over the whole system, and the system control such as maintenance becomes easy because the durability of each cell can be equalized.

In a case of a rod having a cross section S and a length 1, the electric resistance value R can be represented by the equation R=1/Sσ (wherein σ refers to conductivity). If the electric resistance value of each cell can be considered substantially equal to each other, the electric resistance of the current paths in each series direction can be made equal by adjusting the length, the cross section, or the conductivity of the member, except the cell, which forms the current path in a series direction, as an example of the present invention.

For example, the electric resistance can be equalized by adjusting the length in a case of using a material having the same cross section and conductivity, the electric resistance can be equalized by adjusting the conductivity (for example, by using a material having different conductivity) in a case of using a material having the same length and cross section, or the electric resistance can be equalized by adjusting the cross section in a case of using a material having the same length and conductivity. However, the present invention is not limited to these examples. Various embodiments can be selected depending on the design conditions.

According to a second aspect of the present invention, there is provided a solid oxide fuel cell comprising a plurality of cells connected in a series direction and a parallel direction, wherein the sum of the length of the current paths in each series direction is substantially the same.

With this, since electric current can flow uniformly by eliminating the difference in the resistance value, it is possible to conduct electric power generation averagely over the whole system, and the system control such as maintenance becomes easy because the durability of each cell can be equalized.

As a means of substantially equalizing the sum of the length of the current paths in each series direction, it is possible to independently couple the cells to be connected by using substantially the same conductive member as shown in FIG. 4, instead of using the conventional coupling portion.

According to a third aspect of the present invention, there is provided a solid oxide fuel cell comprising a plurality of cells connected in a series direction and a parallel direction, and also comprising a non-parallel portion, wherein the length of the current paths from each of the cells in the parallel direction and adjacent to the non-parallel portion to the end of the non-parallel portion is substantially the same,

With this, since electric current can flow uniformly by eliminating the difference in the resistance value, it is possible to conduct electric power generation uniformly over the whole system, and the system control such as maintenance becomes easy because the durability of each cell can be equalized.

According to an embodiment of this aspect of the present invention, as a coupling portion for connecting two cell stacks, it is possible to employ a structure comprising flat portions which are connected to the cell stacks and a rod portion which electrically connects the flat portions, instead of a simple flat shape.

Since electric current flows through this rod portion, there is no remarkable difference in the length of each current path. Also, by providing many rods in the direction of the cell axis and shifting the connecting position of each rod and the flat portions with respect to the cell parallel direction, it is possible to make the length of the current paths from each cell uniform, make the electric resistance uniform, and prevent electric current from localizing to a particular cell. As a result, it is possible to conduct efficient electric power generation in the whole system, and improve the reliability.

### BRIEF DESCRIPTION OF DRAWINGS

FIG. 1 is a diagram showing an embodiment of a fuel cell according to the present invention;

FIG. 2 is a diagram showing a coupling portion according to an embodiment;

FIG. 3 is a diagram showing a coupling portion according to another embodiment;

FIG. 4 is a diagram showing another embodiment of a fuel cell according to the present invention;

FIG. 5 is a diagram showing another embodiment of a fuel cell according to the present invention;

FIG. 6 is a diagram showing another embodiment of a fuel cell according to the present invention; and

FIG. 7 is a diagram showing an embodiment of a fuel cell having a conventional coupling portion.

### BEST MODE FOR CARRYING OUT THE INVENTION

Hereinafter, the present invention will be described in more detail referring to the drawings.

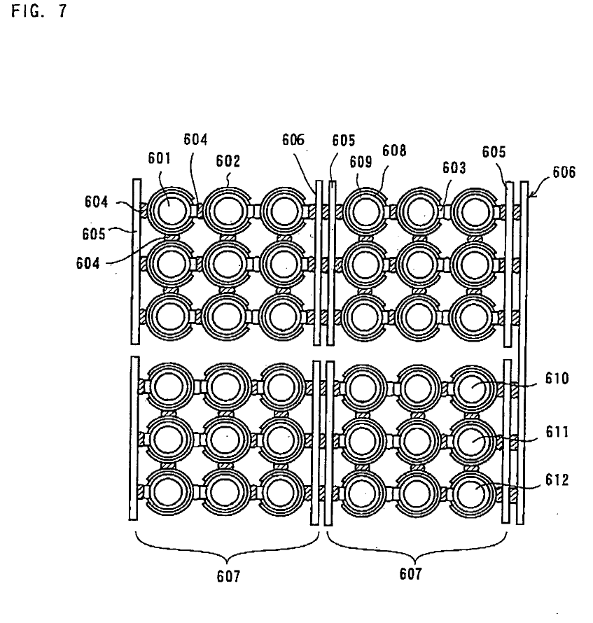

The present invention uses flat portions 102a and a rod 102b instead of the conventional coupling portion 606 as shown in FIG. 7. The flat portions 102a are in contact with a current collecting member 101 which is located at the end of a cell stack (bundle) 103, and the rod 102b connects the flat portions 102a.

Incidentally, a conductive member 104 of a metal felt or the like is provided between the current collecting member 101 and the flat portion 102a. The number of conductive members 104 is not always three, and an integrated one may be used.

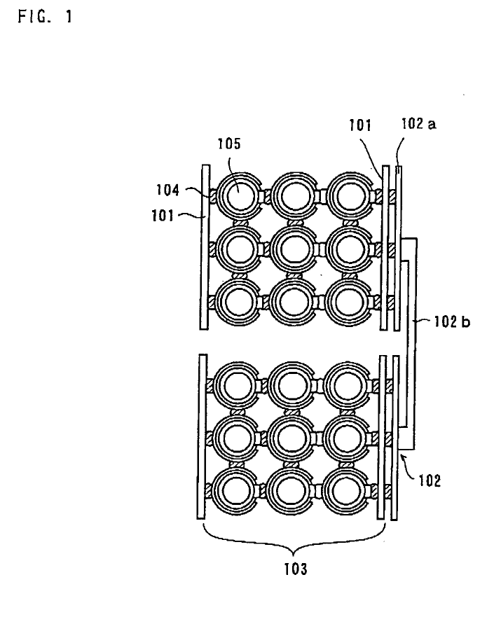

FIG. 1 shows 18 cells 105. Two sets of three cells in the right end of this drawing are connected electrically in series with each other by the coupling portion 102 which is comprised of the flat portions 102a and the rod 102b, In the case of the conventional coupling portion, the length of the conductive material becomes smallest between the cells which are third and fourth from the top, and the electric resistance becomes smallest between those cells, As a result, electric current is localized to those cells among six cells in the right end. The excessive localization of electric current deteriorates the durability of the cells, and also the whole output is relatively decreased compared to a case where electric power generation is conducted uniformly in all the cells.

However, by providing the rod 102b as shown in FIG. 1, electric current flows through the flat portion 102a and the rod 102b, and thereby it is possible to decrease the difference of the length of each conductive material between the cells connected in series.

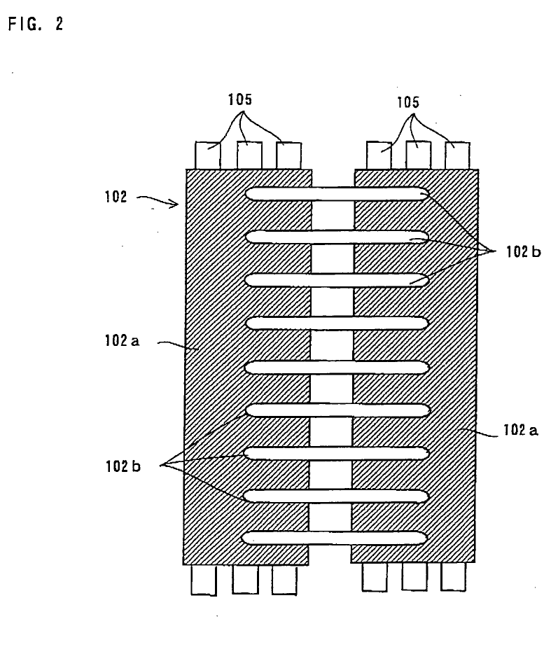

FIG. 2 is a diagram showing an elevation view seen from the side of the coupling portion 102 of FIG. 1. The rod 102b which connects the flat portions 102a is provided in plural in the vertical direction in FIG. 2. However, it is also possible to use a conductive material having a cross section of a “C” shape instead of the plural rods 102b.

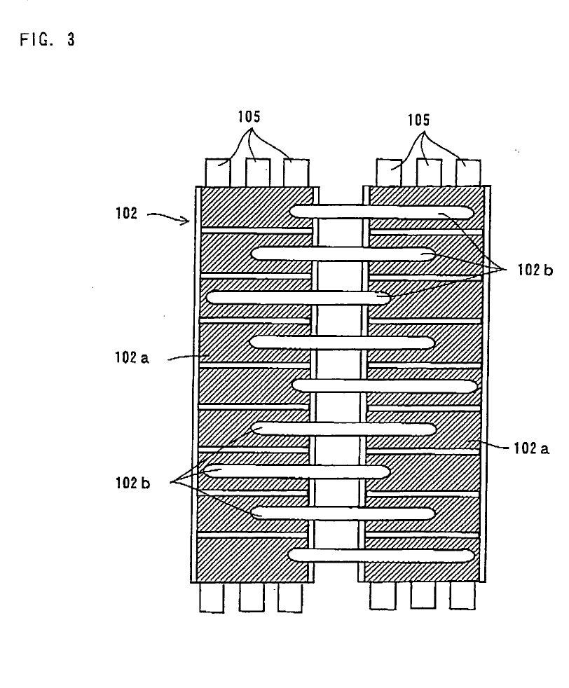

FIG. 3 is a diagram showing another embodiment seen from the side of the coupling portion 102 of FIG. 1. In this embodiment, the flat portion 102a is divided into 9 sections.

In the cases shown in FIG. 1 and FIG. 2, the rod 102b is connected in the center between the flat portions 102a. In this instance, if the number of the parallel connection of the cells is 3 or more, there will be a difference between the cell in the center and the cell in the end of the parallel direction with respect to the resistance of the portion for turning the direction of the series connection, the difference being caused by the distance in the parallel direction. Thus, in the embodiment shown in FIG. 3 in which the flat potion 102a is divided in the cell axis direction and the rod 102b connects the flat portions 102a which are divided with each other, by shifting the connecting position of each rod portion 102b with respect to the cell parallel direction, the electric resistance is allowed to be uniform between the cells in a turned direction of the series connection.

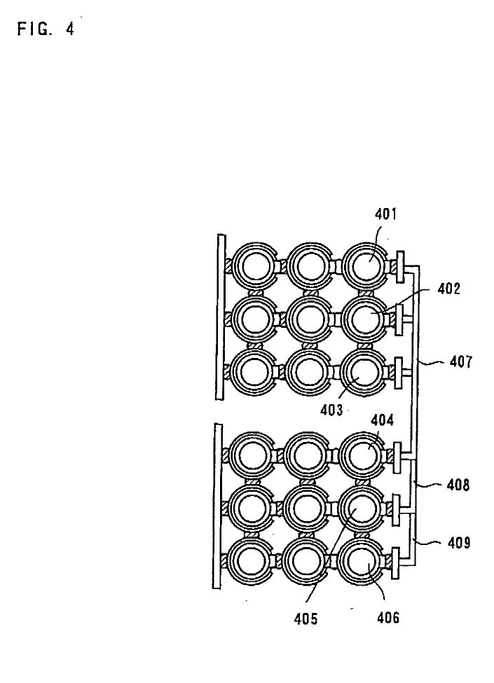

FIG. 4 is a diagram showing another embodiment, and shows only one part of the cell configuration such as shown in FIG. 7. In this embodiment, the coupling portion 606 and the current collecting member 605 are not used. Instead, a cell 401 and a cell 404, a cell 402 and a cell 405, and a cell 403 and a cell 406 are directly connected by a connecting member 407, a connecting member 408, and a connecting member 409 respectively. Each connecting member may be a rod, for example.

Since the length of the connecting member 407, the connecting member 408, and the connecting member 409 is substantially the same, the value of the electric resistance thereof is substantially the same.

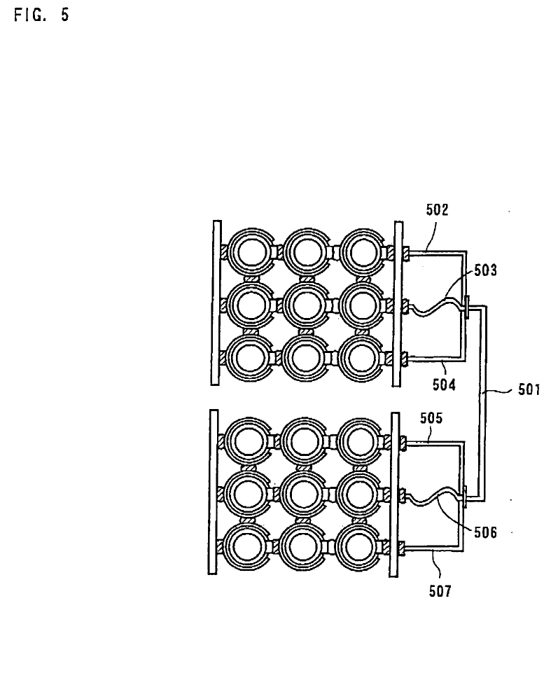

FIG. 5 is a diagram showing another embodiment, and shows only one part of the cell configuration such as shown in FIG. 7. in this embodiment, the coupling portion 606 is not used. Instead, there are provided a coupling member 501, intermediate coupling members 502, 503, and 504 connected to the coupling member, and intermediate coupling members 505, 506 and 507 connected to the cells.

Since the length of the intermediate coupling member 502, 503, 504, 505, 506 and 507 is substantially the same, the value of the electric resistance thereof is substantially the same.

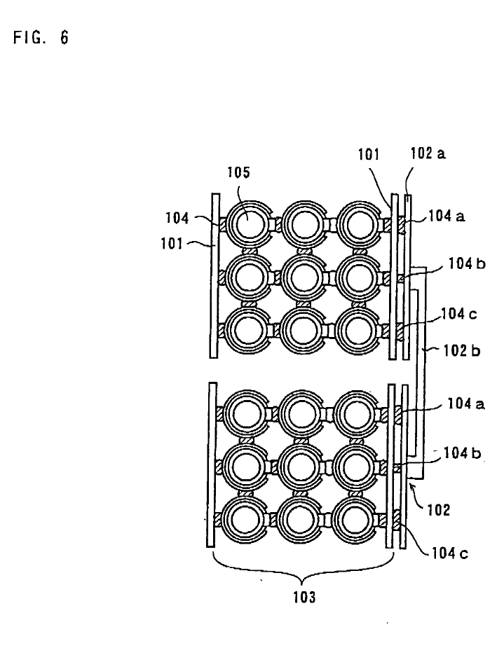

FIG. 6 is a diagram showing a modification of the embodiment shown in FIG. 1. In this case, among the conductive members (metal felt) 104a, 104b, and 104c which electrically connect the current collecting member 101 and the flat portion 102a, the size of the conductive members 104a and 104c distant from the rod 102b are increased, while the size of the conductive member 104b near to the rod 102b is decreased, so that the electric resistance of the conductive member 104b is increased. By doing so, the electric resistance of each current path is allowed to be uniform.

Also, the electric resistance of each current path is allowed to be uniform by using a different material for each conductive member 104a, 104b, and 104c.

### Industrial Applicability

As described above, in the solid oxide fuel cell comprising cylindrical cells according to the present invention, in the case where the cell stacks having a plurality of parallel connections are connected in a non-linear state, electric current can flow uniformly through all the cells which construct the cell stacks, and thereby the amount of electric power generation in the whole system can be increased and the durability can also be improved.

1. A solid oxide fuel cell comprising:
a plurality of cylindrical cells connected in a radial direction, and also in a series direction and a parallel direction;
current collecting members provided at both ends of the series direction;
cell stacks each of which is comprised of said plurality of cylindrical cells and said current collecting members, said cell stacks being disposed in a state of tuning the direction of the positive pole and the negative pole;
conductive flat portions connected to said current collecting members; and
a conductive rod which connects said flat portions;
wherein the sum of the electric resistance of the current paths in each series direction which is turned is substantially the same.

2. The solid oxide fuel cell according to claim 1, wherein said conductive flat portions are divided into plural sections along the direction of the cell axis, each section being connected by the rod, and the position of the rod is shifted with respect to the adjacent rod in the radial direction of the cell.

3. The solid oxide fuel cell according to claim 1, wherein said current collecting members and said conductive flat portions are connected by a metal felt which is provided corresponding to each cell, the size of the metal felt distant from the conductive rod being larger than that of the metal felt near to the conductive rod.

4. A solid oxide fuel cell comprising:
a plurality of cylindrical cells connected in a radial direction, and also in a series direction and a parallel direction;
cell stacks each of which is comprised of said plurality of cylindrical cells, said cell stacks being disposed in a state of turning the direction of the positive pole and the negative pole; and
conductive rods for connecting the positive pole and the negative pole of the cells which are located at one end of each cell stack;
wherein the cells to be connected are selected so that the length of said rods is allowed to be equal.

5. A solid oxide fuel cell comprising:
a plurality of cylindrical cells connected in a radial direction, and also in a series direction and a parallel direction;
current collecting members provided at both ends of the series direction;
cell stacks each of which is comprised of said plurality of cylindrical cells and said current collecting members, said cell stacks being disposed in a state of turning the direction of the positive pole and the negative pole;
intermediate coupling members having the substantially same electric resistance, one ends of the intermediate coupling members being connected to said current collecting members corresponding to each cell, and
a conductive rod to which the other ends of said intermediate coupling members are connected.
